(19) United States
(12) Patent Application Publication
(10) Pub. No.: US 2013/0245188 A1
(43) Pub. Date: Sep. 19, 2013

(54) FLAME-RETARDANT POLYAMIDES WITH LIQUID-CRYSTALLINE POLYESTERS

(71) Applicants: Michael Roth, Lautertal (DE); Uske Klaus, Bad Durkheim (DE); Christoph Minges, Burrweiler (DE)

(72) Inventors: Michael Roth, Lautertal (DE); Uske Klaus, Bad Durkheim (DE); Christoph Minges, Burrweiler (DE)

(73) Assignee: BASF SE, Ludwigshafen (DE)

(21) Appl. No.: 13/706,877

(22) Filed: Dec. 6, 2012

Related U.S. Application Data
(60) Provisional application No. 61/567,698, filed on Dec. 7, 2011.

(51) Int. Cl. C08L 77/00

(52) U.S. Cl. CPC C08L 77/00
USPC 524/539

(57) ABSTRACT

Thermoplastic molding compositions comprising
A) from 10 to 99.6% by weight of a thermoplastic polyamide,
B) from 0.1 to 60% by weight of red phosphorus,
C) from 0.5 to 30% by weight of a liquid-crystalline polyester (LCP),
D) from 0 to 55% by weight of a fibrous or particulate filler or a mixture of these,
E) from 0 to 40% by weight of further additives,
   where the sum of the percentages by weight of A) to E) is 100%.

The invention relates to thermoplastic molding compositions comprising

A) from 10 to 99.6% by weight of a thermoplastic polyamide,
B) from 0.1 to 60% by weight of red phosphorus,
C) from 0.5 to 30% by weight of a liquid-crystalline polyester (LCP),
D) from 0 to 55% by weight of a fibrous or particulate filler or a mixture of these,
E) from 0 to 40% by weight of further additives,
where the sum of the percentages by weight of A) to E) is 100%.

The present invention further relates to the use of these molding compositions for producing fibers, foils, and moldings, and to the resultant moldings, fibers, and foils of any type.

It is known that addition of red phosphorus to thermoplastics, especially to reinforced or filled polyamides, provides effective fire protection (DE-A-1931387). However, under unfavorable conditions, e.g. elevated temperature, moisture, or presence of alkali or oxygen, red phosphorus tends to form decomposition products, such as phosphine and acids of mono- to pentavalent phosphorus. Although red phosphorus incorporated in thermoplastics, e.g. polyamides, has substantial protection from thermal oxidation as a consequence of embedment into the polymer, here again it is possible that decomposition products form over prolonged periods. This is disadvantageous because if pellets are processed incorrectly in the injection-molding process the resultant phosphine can cause odor problems and is moreover toxic. The phosphorus acids which are produced at the same time can exude to the surface of moldings, thus in particular reducing the tracking resistance of the moldings.

There has therefore been no lack of attempts to improve the stability of the red phosphorus used as flame retardant for plastics. By way of example, a stabilizing effect can be achieved via addition of oxides or hydroxides of zinc, of magnesium, or of copper. In DE-A-2625691, in addition to said stabilization via metal oxides, the phosphorus particles are coated with a polymer. This coating or encapsulation process is however very complicated, and the stabilizing effect of the system is moreover not always satisfactory.

The present invention was therefore based on the object of providing thermoplastic molding compositions which comprise, as flame retardant, a red phosphorus that has been effectively stabilized, so that the molding compositions exhibit less phosphorus exudation, and also less formation of phosphinic acid. A further intention is to achieve good stability during processing and particularly homogeneous dispersibility in the plastics melt.

Accordingly, the molding compositions defined in the introduction have been discovered. Preferred embodiments can be found in the dependent claims.

The molding compositions of the invention comprise, as component A), from 10 to 99.6% by weight, preferably from 20 to 94% by weight, and in particular from 50 to 80% by weight, of at least one polyamide.

The polyamides of the molding compositions of the invention generally have an intrinsic viscosity of from 90 to 350 ml/g, preferably from 110 to 240 ml/g, determined in a 0.5% strength by weight solution in 96% strength by weight sulfuric acid at 25° C. to ISO 307.

Preference is given to semicrystalline or amorphous resins with a molecular weight (weight average) of at least 5000, described by way of example in the following U.S. Pat. Nos. 2,071,250, 2,071,251, 2,130,523, 2,130,948, 2,241,322, 2,312,966, 2,512,606, and 3,393,210.

Examples of these are polyamides that derive from lactams having from 7 to 13 ring members, e.g. polycaprolactam, polycapryllactam, and polylaurolactam, and also polyamides obtained via reaction of dicarboxylic acids with diamines.

Dicarboxylic acids which may be used are alkanedicarboxylic acids having from 6 to 12, in particular from 6 to 10, carbon atoms, and aromatic dicarboxylic acids. Merely as examples, acids that may be mentioned here are adipic acid, azelaic acid, sebacic acid, dodecanedioic acid and terephthalic and/or isophthalic acid.

Particularly suitable diamines are alkanediamines having from 6 to 12, in particular from 6 to 8, carbon atoms, and also m-xylylenediamine (e.g. Ultramid® X17 from BASF SE, where the molar ratio of MXDA to adipic acid is 1:1), di(4-aminophenyl)methane, di(4-aminocyclohexyl)methane, 2,2-di(4-aminophenyl)propane, 2,2-di(4-aminocyclohexyl)propane, and 1,5-diamino-2-methylpentane.

Preferred polyamides are polyhexamethyleneadipamide, polyhexamethylenesebacamide, and polycaprolactam, and also nylon-6/6,6 copolyamides, in particular having a proportion of from 5 to 95% by weight of caprolactam units (e.g. Ultramid® C31 from BASF SE).

Other suitable polyamides are obtainable from w-aminoalkylnitriles, e.g. aminocapronitrile (PA 6) and adiponitrile with hexamethylenediamine (PA 66) via what is known as direct polymerization in the presence of water, for example as described in DE-A 10313681, EP-A 1198491 and EP 922065.

Mention may also be made of polyamides obtainable, by way of example, via condensation of 1,4-diaminobutane with adipic acid at an elevated temperature (nylon-4,6). Preparation processes for polyamides of this structure are described by way of example in EP-A 38 094, EP-A 38 582, and EP-A 39 524.

Other suitable examples are polyamides obtainable via copolymerization of two or more of the abovementioned monomers, and mixtures of two or more polyamides in any desired mixing ratio. Particular preference is given to mixtures of nylon-6,6 with other polyamides, in particular nylon-6/6,6 copolyamides.

Other copolyamides which have proven particularly advantageous are semiaromatic copolyamides, such as PA 6/6T and PA 66/6T, where the triamine content of these is less than 0.5% by weight, preferably less than 0.3% by weight (see EP-A 299 444). Other polyamides resistant to high temperatures are known from EP-A 19 94 075 (PA 6T/61/MXD6).

The processes described in EP-A 129 195 and 129 196 can be used to prepare the preferred semiaromatic copolyamides with low triamine content.

The following list, which is not comprehensive, comprises the polyamides A) mentioned and other polyamides A) for the purposes of the invention, and the monomers comprised:

### AB Polymers:

### PA 4 Pyrrolidone

### PA 6 ε-Caprolactam

### PA 7 Ethanolactam

### PA 8 Capryllactam

PA 9 9-Aminopelargonic acid
PA 11 11-Aminoundecanoic acid

### PA 12 Laurolactam

AA/BB polymers:
PA 46 Tetramethylenediamine, adipic acid
PA 66 Hexamethylenediamine, adipic acid
PA 69 Hexamethylenediamine, azelaic acid
PA 610 Hexamethylenediamine, sebacic acid
PA 612 Hexamethylenediamine, decanedicarboxylic acid
PA 613 Hexamethylenediamine, undecanedicarboxylic acid
PA 1212 1,12-Dodecanediamine, decanedicarboxylic acid
PA 1313 1,13-Diaminotridecane, undecanedicarboxylic acid
PA 6T Hexamethylenediamine, terephthalic acid
PA 9T 1,9-Nonanediamine, terephthalic acid
PA MXD6 m-Xylylenediamine, adipic acid
AA/BB polymers
PA 61 Hexamethylenediamine, isophthalic acid
PA 6-3-T Trimethylhexamethylenediamine, terephthalic acid

### PA 6/6T (see PA 6 and PA 6T)

### PA 6/66 (see PA 6 and PA 66)

### PA 6/12 (see PA 6 and PA 12)

### PA 66/6/610 (see PA 66, PA 6 and PA 610)

### PA 6I/6T (see PA 61 and PA 6T)

PA PACM 12 Diaminodicyclohexylmethane, laurolactam
PA 6I/6T/PACM as PA 6I/6T+diaminodicyclohexylmethane
PA 12/MACMI Laurolactam, dimethyldiaminodicyclohexylmethane, isophthalic acid
PA 12/MACMT Laurolactam, dimethyldiaminodicyclohexylmethane, terephthalic acid
PA PDA-T Phenylenediamine, terephthalic acid

Preferred flame retardant B) is elemental red phosphorus, in particular in combination with glassfiber-reinforced molding compositions; this phosphorus can be used in untreated form.

However, particularly suitable preparations are those in which the phosphorus has been surface-treated with low-molecular-weight liquid substances, such as silicone oil, paraffin oil, or esters of phthalic acid (in particular dioctyl phthalate, see EP 176 836) or adipic acid, or with polymeric or oligomeric compounds, e.g. with phenolic resins or amino plastics, or else polyurethanes (see EP-A 384 232, DE-A 196 48 503). The amounts comprised of these materials known as phlegmatizers are generally from 0.05 to 5% by weight, based on 100% by weight of B).

Concentrates of red phosphorus, e.g. in a polyamide or elastomer, are also suitable as flame retardant. Particularly suitable concentrate polymers are polyolefin homo- and copolymers. However, the proportion of the concentrate polymer in the molding compositions of the invention, based on the weight of components A) and B), should not be more than 35% by weight—unless polyamide is used as thermoplastic.

Preferred concentrate constitutions are
B₁) from 30 to 90% by weight, preferably from 45 to 70% by weight, of a polyamide or elastomer,
B₂) from 10 to 70% by weight, preferably from 30 to 55% by weight, of red phosphorus.

The polyamide used for the masterbatch can differ from A) or preferably can be the same as A), so that no adverse effect on the molding composition arises from incompatibility phenomena or melting point differences.

The average particle size (d₅₀) of the phosphorus particles dispersed in the molding compositions is preferably in the range from 0.0001 to 0.5 mm; in particular from 0.001 to 0.2 mm.

The content of component B) in the molding compositions of the invention is from 0.1 to 60% by weight, preferably from 0.5 to 40% by weight, and in particular from 1 to 15% by weight, based on the entirety of components A) to E).

The molding compositions of the invention comprise, as component C), from 0.5 to 30% by weight, preferably from 0.5 to 15% by weight, and in particular from 1 to 10% by weight, of a liquid-crystalline polyester (also termed LCP).

These polymers are known inter alia from H.-G. Elias, An Introduction to Plastics. 1st edition 1993, VCH Verlagsgesellschaft mbH, Weinheim, pp. 254-255. In Römpp's Chemielexikon [Römpp's chemical encyclopedia], online version 3.12, chapter on “Polyarylates”, 2008, the production process either uses interfacial condensation of the appropriate acyl chlorides (e.g. terephthoyl dichloride) with sodium phenolates or preferably uses polycondensation of aromatic hydroxycarboxylic acids, in particular 4-hydroxybenzoic acid, 6-hydroxynaphthalenecarboxylic acid, or acetates thereof, with elimination of acetic acid (see EP0133024 A2).

Preference is given to polyesters C) composed of
C₁) from 70 to 100 mol % of units which derive from bisphenol A, from aromatic carboxylic acids, or from a mixture of these, and
C₂) from 0 to 30 mol % of alkanediols having from 2 to 4 carbon atoms,
   where the entirety of C₁) and C₂) gives 100%.

Suitable units C₁) are those derived from

bisphenol A

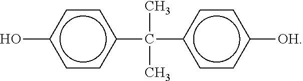

and from aromatic dicarboxylic acids, such as

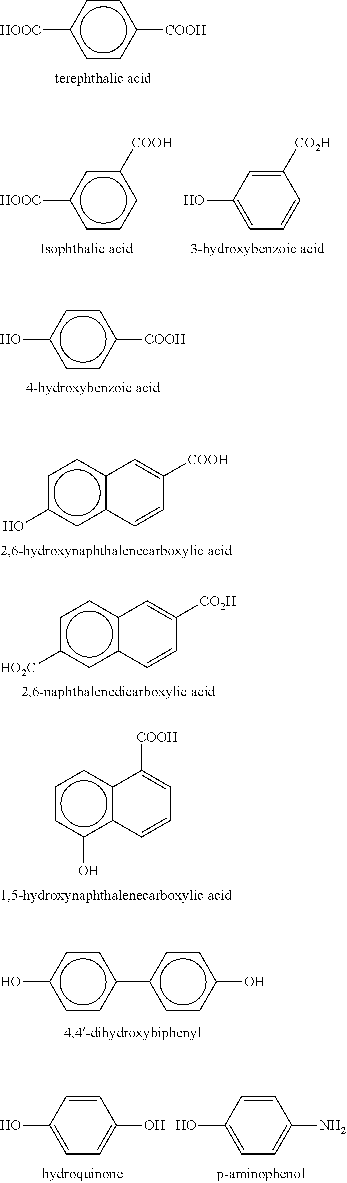

or a mixture of these.

Other suitable monomers are:

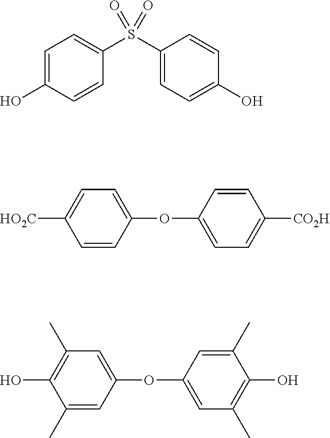 [SMILES: O=S(=O)(c1ccc(O)cc1)c1ccc(O)cc1 ; O=C(O)c1ccc(Oc2ccc(C(=O)O)cc2)cc1 ; Cc1cc(Oc2cc(C)c(O)c(C)c2)cc(C)c1O]

Comonomers C₂) used can be alkanediols having from 2 to 4 carbon atoms, preference being given here to ethylene glycol.

Preferred polyesters C) are those composed of:
C₁₁) from 50 to 90 mol % of 4-hydroxybenzoic acid
C₁₂) from 10 to 30 mol % of terephthalic acid or 1,5- or 2,6-hydroxynaphthalenecarboxylic acid or 4,4′-dihydroxybiphenyl, or a mixture of these, and
C₂) from 0 to 20 mol % of ethylene glycol.

Preference is given to thermotropic liquid-crystalline polyesters composed of
a) 60 mol % of hydroxybenzoic acid+20 mol % of terephthalic acid+20 mol % of ethylene glycol (known with trade name X7G from Eastman)
b) 68 mol % of 4-hydroxybenzoic acid+16 mol % of terephthalic acid+16 mol % of dihydroxybiphenyl (known with trademark Xydar® SRT 300 from Solvay)
c) 73 mol % of 4-hydroxybenzoic acid+27 mol % of 2,6-hydroxynaphthalenecarboxylic acid (known with trademark Vectra® A950 from Ticona).

Fibrous or particulate fillers D) that may be mentioned are carbon fibers, glass fibers, glass beads, amorphous silica, calcium silicate, calcium metasilicate, magnesium carbonate, kaolin, chalk, powdered quartz, mica, barium sulfate, and feldspat, and the amounts that can be used of these are from 0 to 55% by weight, preferably from 5 to 50% by weight, in particular from 10 to 40% by weight.

Preferred fibrous fillers that may be mentioned are carbon fibers, aramid fibers, and potassium titanate fibers, particular preference being given to glass fibers in the form of E glass. These can be used as rovings or in the commercially available forms of chopped glass.

The fibrous fillers may have been surface-pretreated with a silane compound to improve compatibility with the thermoplastics.

Suitable silane compounds have the general formula:

(X—(CH₂)ₙ)ₖ—Si—(O—CₘH₂ₘ₊₁)₄₋ₖ

where the definitions of the substituents are as follows:

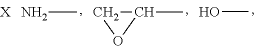

n is a whole number from 2 to 10, preferably 3 to 4,
m is a whole number from 1 to 5, preferably 1 to 2, and
k is a whole number from 1 to 3, preferably 1.

Preferred silane compounds are aminopropyltrimethoxysilane, aminobutyltrimethoxysilane, aminopropyltriethoxysilane and aminobutyltriethoxysilane, and also the corresponding silanes which comprise a glycidyl group as substituent X.

The amounts of the silane compounds generally used for surface-coating are from 0.01 to 2% by weight, preferably from 0.025 to 1.0% by weight and in particular from 0.05 to 0.5% by weight (based on D)).

Acicular mineral fillers are also suitable.

For the purposes of the invention, acicular mineral fillers are mineral fillers with strongly developed acicular character. An example is acicular wollastonite. The mineral preferably has an L/D (length to diameter) ratio of from 8:1 to 35:1, preferably from 8:1 to 11:1. The mineral filler may optionally have been pretreated with the abovementioned silane compounds, but the pretreatment is not essential.

Other fillers which may be mentioned are kaolin, calcined kaolin, wollastonite, talc and chalk, and also lamellar or acicular nanofillers, the amounts of these preferably being from 0.1 to 10%. Materials preferred for this purpose are boehmite, bentonite, montmorillonite, vermiculite, hectorite, and laponite. The lamellar nanofillers are organically modified by prior-art methods, to give them good compatibility with the organic binder. Addition of the lamellar or acicular nanofillers to the inventive nanocomposites gives a further increase in mechanical strength.

The molding compositions can comprise, as component E), amounts of from 0 to 40% by weight, preferably from 0 to 30% by weight, of further additives.

Suitable additives are elastomeric polymers (often also termed impact modifiers, elastomers, or rubbers), and the amounts comprised of these can be from 0 from 20% by weight, preferably from 2 to 10% by weight.

These are very generally copolymers preferably composed of at least two of the following monomers: ethylene, propylene, butadiene, isobutene, isoprene, chloroprene, vinyl acetate, styrene, acrylonitrile, and acrylic or methacrylic esters having from 1 to 18 carbon atoms in the alcohol component.

Polymers of this type are described, for example, in Houben-Weyl, Methoden der organischen Chemie, Vol. 14/1 (Georg-Thieme-Verlag, Stuttgart, Germany, 1961), pages 392-406, and in the monograph by C. B. Bucknall, “Toughened Plastics” (Applied Science Publishers, London, UK, 1977).

Some preferred types of these elastomers are described below.

Preferred types of these elastomers are those known as ethylene-propylene (EPM) and ethylene-propylene-diene (EPDM) rubbers.

EPM rubbers generally have practically no residual double bonds, whereas EPDM rubbers may have from 1 to 20 double bonds per 100 carbon atoms.

Examples which may be mentioned of diene monomers for EPDM rubbers are conjugated dienes, such as isoprene and butadiene, non-conjugated dienes having from 5 to 25 carbon atoms, such as 1,4-pentadiene, 1,4-hexadiene, 1,5-hexadiene, 2,5-dimethyl-1,5-hexadiene and 1,4-octadiene, cyclic dienes, such as cyclopentadiene, cyclohexadienes, cyclooctadienes and dicyclopentadiene, and also alkenylnorbornenes, such as 5-ethylidene-2-norbornene, 5-butylidene-2-norbornene, 2-methallyl-5-norbornene and 2-isopropenyl-5-norbornene, and tricyclodienes, such as 3-methyltricyclo[5.2.1.0^{2,6}]-3,8-decadiene, and mixtures of these. Preference is given to 1,5-hexadiene, 5-ethylidenenorbornene and dicyclopentadiene. The diene content of the EPDM rubbers is preferably from 0.5 to 50% by weight, in particular from 1 to 8% by weight, based on the total weight of the rubber.

EPM rubbers and EPDM rubbers may preferably also have been grafted with reactive carboxylic acids or with derivatives of these. Examples of these are acrylic acid, methacrylic acid and derivatives thereof, e.g. glycidyl (meth)acrylate, and also maleic anhydride.

Copolymers of ethylene with acrylic acid and/or methacrylic acid and/or with the esters of these acids are another group of preferred rubbers. The rubbers may also comprise dicarboxylic acids, such as maleic acid and fumaric acid, or derivatives of these acids, e.g. esters and anhydrides, and/or monomers comprising epoxy groups. These monomers comprising dicarboxylic acid derivatives and/or comprising epoxy groups are preferably incorporated into the rubber by adding to the monomer mixture monomers comprising dicarboxylic acid groups and/or epoxy groups and having the general formulae I or II or Ill or IV

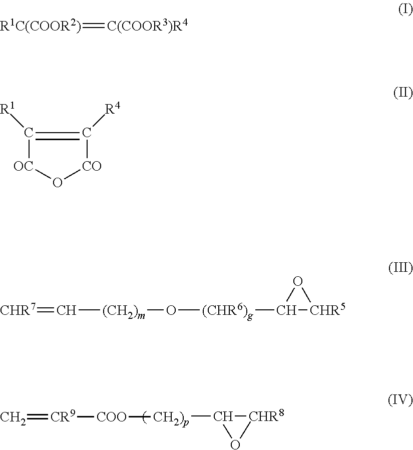

where R¹ to R⁹ are hydrogen or alkyl groups having from 1 to 6 carbon atoms, and m is a whole number from 0 to 20, g is a whole number from 0 to 10 and p is a whole number from 0 to 5.

The radicals R¹ to R⁹ are preferably hydrogen, where m is 0 or 1 and g is 1. The corresponding compounds are maleic acid, fumaric acid, maleic anhydride, allyl glycidyl ether and vinyl glycidyl ether.

Preferred compounds of the formulae I, II and IV are maleic acid, maleic anhydride and (meth)acrylates comprising epoxy groups, such as glycidyl acrylate and glycidyl methacrylate, and the esters with tertiary alcohols, such as tert-butyl acrylate. Although the latter have no free carboxy groups, their behavior approximates to that of the free acids and they are therefore termed monomers with latent carboxy groups.

The copolymers are advantageously composed of from 50 to 98% by weight of ethylene, from 0.1 to 20% by weight of monomers comprising epoxy groups and/or methacrylic acid and/or monomers comprising acid anhydride groups, the remaining amount being (meth)acrylates.

Particular preference is given to copolymers composed of
from 50 to 98% by weight, in particular from 55 to 95% by weight, of ethylene,
from 0.1 to 40% by weight, in particular from 0.3 to 20% by weight, of glycidyl acrylate and/or glycidyl methacrylate, (meth)acrylic acid and/or maleic anhydride, and
from 1 to 45% by weight, in particular from 5 to 40% by weight, of n-butyl acrylate and/or 2-ethylhexyl acrylate.

Other preferred (meth)acrylates are the methyl, ethyl, propyl, isobutyl and tert-butyl esters.

Comonomers which may be used alongside these are vinyl esters and vinyl ethers.

The ethylene copolymers described above may be prepared by processes known per se, preferably by random copolymerization at high pressure and elevated temperature. Appropriate processes are well-known.

Other preferred elastomers are emulsion polymers whose preparation is described, for example, by Blackley in the monograph “Emulsion Polymerization”. The emulsifiers and catalysts which can be used are known per se.

In principle it is possible to use homogeneously structured elastomers or else those with a shell structure. The shell-type structure is determined by the sequence of addition of the individual monomers. The morphology of the polymers is also affected by this sequence of addition.

Monomers which may be mentioned here, merely as examples, for the preparation of the rubber fraction of the elastomers are acrylates, such as n-butyl acrylate and 2-ethylhexyl acrylate, corresponding methacrylates, butadiene and isoprene, and also mixtures of these. These monomers may be copolymerized with other monomers, such as styrene, acrylonitrile, vinyl ethers and with other acrylates or methacrylates, such as methyl methacrylate, methyl acrylate, ethyl acrylate or propyl acrylate.

The soft or rubber phase (with a glass transition temperature of below 0° C.) of the elastomers may be the core, the outer envelope or an intermediate shell (in the case of elastomers whose structure has more than two shells). Elastomers having more than one shell may also have more than one shell composed of a rubber phase.

If one or more hard components (with glass transition temperatures above 20° C.) are involved, besides the rubber phase, in the structure of the elastomer, these are generally prepared by polymerizing, as principal monomers, styrene, acrylonitrile, methacrylonitrile, α-methylstyrene, p-methylstyrene, acrylates or methacrylates, such as methyl acrylate, ethyl acrylate or methyl methacrylate. Besides these, it is also possible to use relatively small proportions of other comonomers.

It has proven advantageous in some cases to use emulsion polymers which have reactive groups at their surfaces. Examples of groups of this type are epoxy, carboxy, latent carboxy, amino and amide groups, and also functional groups which may be introduced by concomitant use of monomers of the general formula

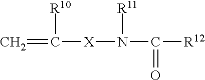

where the substituents can be defined as follows:
R¹⁰ is hydrogen or a C₁-C₄-alkyl group,
R¹¹ is hydrogen, a C₁-C₈-alkyl group or an aryl group, in particular phenyl,
R¹² is hydrogen, a C₁-C₁₀-alkyl group, a C₆-C₁₂-aryl group, or —OR¹³,
R¹³ is a C₁-C₈-alkyl group or a C₆-C₁₂-aryl group, which can optionally have substitution by groups that comprise 0 or by groups that comprise N,
X is a chemical bond, a C₁-C₁₀-alkylene group, or a C₆-C₁₂-arylene group, or

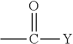

Y is O—Z or NH—Z, and
Z is a C₁-C₁₀-alkylene or C₆-C₁₂-arylene group.

The graft monomers described in EP-A 208 187 are also suitable for introducing reactive groups at the surface.

Other examples which may be mentioned are acrylamide, methacrylamide and substituted acrylates or methacrylates, such as (N-tert-butylamino)ethyl methacrylate, (N,N-dimethylamino)ethyl acrylate, (N,N-dimethylamino)methyl acrylate and (N,N-diethylamino)ethyl acrylate.

The particles of the rubber phase may also have been crosslinked. Examples of crosslinking monomers are 1,3-butadiene, divinylbenzene, diallyl phthalate and dihydrodicyclopentadienyl acrylate, and also the compounds described in EP-A 50 265.

It is also possible to use the monomers known as graft-linking monomers, i.e. monomers having two or more polymerizable double bonds which react at different rates during the polymerization. Preference is given to the use of compounds of this type in which at least one reactive group polymerizes at about the same rate as the other monomers, while the other reactive group (or reactive groups), for example, polymerize(s) significantly more slowly. The different polymerization rates give rise to a certain proportion of unsaturated double bonds in the rubber. If another phase is then grafted onto a rubber of this type, at least some of the double bonds present in the rubber react with the graft monomers to form chemical bonds, i.e. the phase grafted on has at least some degree of chemical bonding to the graft base.

Examples of graft-linking monomers of this type are monomers comprising allyl groups, in particular allyl esters of ethylenically unsaturated carboxylic acids, for example allyl acrylate, allyl methacrylate, diallyl maleate, diallyl fumarate and diallyl itaconate, and the corresponding monoallyl compounds of these dicarboxylic acids. Besides these there is a wide variety of other suitable graft-linking monomers. For further details reference may be made here, for example, to U.S. Pat. No. 4,148,846.

The proportion of these crosslinking monomers in the impact-modifying polymer is generally up to 5% by weight, preferably not more than 3% by weight, based on the impact-modifying polymer.

Some preferred emulsion polymers are listed below. Mention may first be made here of graft polymers with a core and with at least one outer shell, and having the following structure:

| Type | Monomers for the core | Monomers for the envelope |
|---|---|---|
| I | 1,3-butadiene, isoprene, | styrene, acrylonitrile, methyl |
| | n-butyl acrylate, ethyl- | methacrylate |
| | hexyl acrylate, or a mix- | |
| | ture of these | |
| II | as I, but with concomitant | as I |
| | use of crosslinking agents | |
| III | as I or II | n-butyl acrylate, ethyl acrylate, |
| | | methyl acrylate, 1,3-butadiene, |
| | | isoprene, ethylhexyl acrylate |
| IV | as I or II | as I or III, but with concomitant |
| | | use of monomers having reactive |
| | | groups, as described herein |
| V | styrene, acrylonitrile, | first envelope composed of |
| | methyl methacrylate, or | monomers as described under I |
| | a mixture of these | and II for the core, second |
| | | envelope as described under I |
| | | or IV for the envelope |

Instead of graft polymers whose structure has more than one shell, it is also possible to use homogeneous, i.e. single-shell, elastomers composed of 1,3-butadiene, isoprene and n-butyl acrylate or of copolymers of these. These products, too, may be prepared by concomitant use of crosslinking monomers or of monomers having reactive groups.

Examples of preferred emulsion polymers are n-butyl acrylate-(meth)acrylic acid copolymers, n-butyl acrylate-glycidyl acrylate or n-butyl acrylate-glycidyl methacrylate copolymers, graft polymers with an inner core composed of n-butyl acrylate or based on butadiene and with an outer envelope composed of the abovementioned copolymers, and copolymers of ethylene with comonomers which supply reactive groups.

The elastomers described may also be prepared by other conventional processes, e.g. by suspension polymerization.

Preference is also given to silicone rubbers, as described in DE-A 37 25 576, EP-A 235 690, DE-A 38 00 603 and EP-A 319 290.

Particularly preferred rubbers E) are ethylene copolymers, as described above, which comprise functional monomers, where the functional monomers have been selected from the group of the carboxylic acid groups, carboxylic anhydride groups, carboxylic ester groups, carboxamide groups, carboximide groups, amino groups, hydroxy groups, epoxy groups, urethane groups, and oxazoline groups, and mixtures of these.

The proportion of the functional groups is from 0.1 to 20% by weight, preferably from 0.2 to 10% by weight, and in particular from 0.3 to 3.5% by weight, based on 100% by weight of E).

Particularly preferred monomers are composed of an ethylenically unsaturated mono- or dicarboxylic acid or of a functional derivative of such an acid.

Compounds in principle suitable are any of the primary, secondary, and tertiary C₁-C₁₈-alkyl esters of acrylic acid or methacrylic acid, but preference is given to esters having from 1 to 12 carbon atoms, in particular having from 2 to 10 carbon atoms.

Examples of these are methyl, ethyl, propyl, n-butyl, isobutyl, and tert-butyl, 2-ethylhexyl, octyl, and decyl acrylates and the corresponding esters of methacrylic acid. Among these, particular preference is given to n-butyl acrylate and 2-ethylhexyl acrylate.

The olefin polymers can also comprise, instead of the esters or in addition to these, acid-functional and/or latently acid-functional monomers of ethylenically unsaturated mono- or dicarboxylic acids, or monomers having epoxy groups.

Further examples that may be mentioned of monomers are acrylic acid, methacrylic acid, tertiary alkyl esters of these acids, in particular tert-butyl acrylate, and dicarboxylic acids, such as maleic acid and fumaric acid, and derivatives of these acids, and also monoesters thereof.

Latently acid-functional monomers are compounds which under the polymerization conditions or during incorporation of the olefin polymers into the molding compositions form free acid groups. Examples that may be mentioned of these are anhydrides of dicarboxylic acids having up to 20 carbon atoms, in particular maleic anhydride, and tertiary C₁-C₁₂-alkyl esters of the abovementioned acids, in particular tert-butyl acrylate and tert-butyl methacrylate.

The acid-functional or latently acid-functional monomers and the monomers comprising epoxy groups are preferably incorporated into the olefin polymers via addition of compounds of the general formulae I-IV to the monomer mixture.

The melt index of the ethylene copolymers is generally in the range from 1 to 80 g/10 min (measured at 190° C. with 2.16 kg load).

The molar mass of these ethylene-α-olefin copolymers is from 10 000 to 500 000 g/mol, preferably from 15 000 to 400 000 g/mol (Mn, determined by means of GPC in 1,2,4-trichlorobenzene with PS calibration).

In one particular embodiment, ethylene-α-olefin copolymers produced by means of what are known as “single site catalysts” are used. Further details can be found in U.S. Pat. No. 5,272,236. The molecular weight polydispersity of the ethylene-α-olefin copolymers here is narrow for polyolefins: smaller than 4, preferably smaller than 3.5.

Commercially available products used with preference are Exxelor® VA 1801 and 1803, Kraton® G 1901 FX and Fusabond® N NM493 D and Fusabond® A560 from Exxon, Kraton, and DuPont, and also Tafiner®MH 7010 from Mitsui.

It is also possible, of course, to use a mixture of the types of rubber listed above.

The molding compositions of the invention can comprise, as component E), from 0.05 to 3% by weight, preferably from 0.1 to 1.5% by weight, and in particular from 0.1 to 1% by weight, of a lubricant.

Preference is given to the salts of Al, of alkali metals, or of alkaline earth metals, or esters or amides of fatty acids having from 10 to 44 carbon atoms, preferably having from 12 to 44 carbon atoms.

The metal ions are preferably alkaline earth metal and Al, particular preference being given to Ca or Mg.

Preferred metal salts are Ca stearate and Ca montanate, and also Al stearate.

It is also possible to use a mixture of various salts, in any desired mixing ratio.

The carboxylic acids can be monobasic or dibasic. Examples which may be mentioned are pelargonic acid, palmitic acid, lauric acid, margaric acid, dodecanedioic acid, behenic acid, and particularly preferably stearic acid, capric acid, and also montanic acid (a mixture of fatty acids having from 30 to 40 carbon atoms).

The aliphatic alcohols can be monohydric to tetrahydric. Examples of alcohols are n-butanol, n-octanol, stearyl alcohol, ethylene glycol, propylene glycol, neopentyl glycol, pentaerythritol, preference being given to glycerol and pentaerythritol.

The aliphatic amines can be mono- to tribasic. Examples of these are stearylamine, ethylenediamine, propylenediamine, hexamethylenediamine, di(6-aminohexyl)amine, particular preference being given to ethylenediamine and hexamethylenediamine. Preferred esters or amides are correspondingly glycerol distearate, glycerol tristearate, ethylenediamine distearate, glycerol monopalmitate, glycerol trilaurate, glycerol monobehenate, and pentaerythritol tetrastearate.

It is also possible to use a mixture of various esters or amides, or of esters with amides in combination, in any desired mixing ratio.

The molding compositions of the invention can comprise, as component E), from 0.05 to 3% by weight, preferably from 0.1 to 1.5% by weight, and in particular from 0.1 to 1% by weight, of a copper stabilizer, preferably of a Cu(I) halide, in particular in a mixture with an alkali metal halide, preferably KI, in particular in the ratio 1:4.

Preferred salts of monovalent copper that can be used are Cu(I) complexes with PPh₃, copper (I) acetate, copper(I) chloride, copper(I) bromide and copper(I) iodide. The amounts comprised of these are from 5 to 500 ppm of copper, preferably from 10 to 250 ppm, based on polyamide.

The advantageous properties are in particular obtained if the copper is present with molecular distribution in the polyamide. This is achieved if a concentrate comprising polyamide, and comprising a salt of monovalent copper, and comprising an alkali metal halide in the form of a solid, homogeneous solution is added to the molding composition. By way of example, a typical concentrate is composed of from 79 to 95% by weight of polyamide and from 21 to 5% by weight of a mixture composed of copper iodide or copper bromide and potassium iodide. The copper concentration in the solid homogeneous solution is preferably from 0.3 to 3% by weight, in particular from 0.5 to 2% by weight, based on the total weight of the solution, and the molar ratio of copper(I) iodide to potassium iodide is from 1 to 11.5, preferably from 1 to 5.

Suitable polyamides for the concentrate are homopolyamides and copolyamides, in particular nylon-6 and nylon-6,6.

Suitable sterically hindered phenols E) are in principle all of the compounds which have a phenolic structure and which have at least one bulky group on the phenolic ring.

It is preferable to use, for example, compounds of the formula

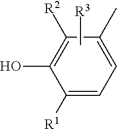

where:
R¹ and R² are an alkyl group, a substituted alkyl group, or a substituted triazole group, and where the radicals R¹ and R² may be identical or different, and R³ is an alkyl group, a substituted alkyl group, an alkoxy group, or a substituted amino group.

Antioxidants of the abovementioned type are described by way of example in DE-A 27 02 661 (U.S. Pat. No. 4,360,617).

Another group of preferred sterically hindered phenols is derived from substituted benzenecarboxylic acids, in particular from substituted benzenepropionic acids.

Particularly preferred compounds from this class are compounds of the formula

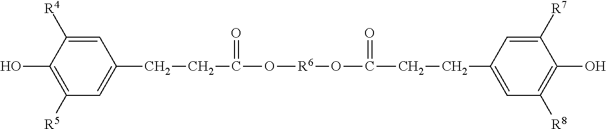

where R⁴, R⁵, R⁷, and R⁸, independently of one another, are C₁-C₈-alkyl groups which themselves may have substitution (at least one of these being a bulky group), and R⁶ is a divalent aliphatic radical which has from 1 to 10 carbon atoms and whose main chain may also have C—O bonds.

Preferred compounds corresponding to this formula are

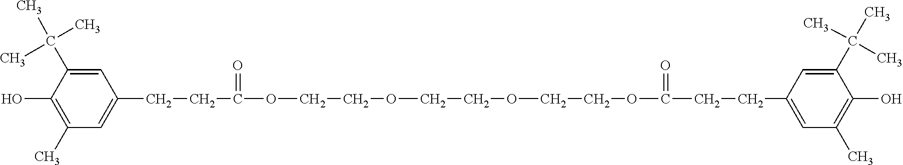 [SMILES: Cc1cc(CCC(=O)OCCOCCOCCOC(=O)CCc2cc(C)c(O)c(C(C)(C)C)c2)cc(C(C)(C)C)c1O]

(Irganox® 245 from BASF SE)

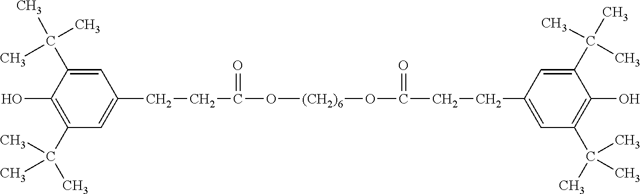

(Irganox® 259 from BASF SE)

All of the following should be mentioned as examples of sterically hindered phenols:

2,2′-methylenebis(4-methyl-6-tert-butylphenol), 1,6-hexanediol bis[3-(3,5-di-tert-butyl-4-hydroxyphenol)propionate], pentaerythrityl tetrakis[3-(3,5-di-tert-butyl-4-hydroxyphenyl)-propionate], distearyl 3,5-di-tert-butyl-4-hydroxybenzylphosphonate, 2,6,7-trioxa-1-phosphabicyclo[2.2.2]oct-4-ylmethyl 3,5-di-tert-butyl-4-hydroxyhydrocinnamate, 3,5-di-tert-butyl-4-hydroxyphenyl-3,5-distearylthiotriazylamine, 2-(2′-hydroxy-3′-hydroxy-3′,5′-di-tert-butylphenyl)-5-chlorobenzotriazole, 2,6-di-tert-butyl-4-hydroxymethylphenol, 1,3,5-trimethyl-2,4,6-tris(3,5-di-tert-butyl-4-hydroxybenzyl)benzene, 4,4′-methylenebis(2,6-di-tert-butylphenol), 3,5-di-tert-butyl-4-hydroxybenzyldimethylamine.

Compounds which have proven particularly effective and which are therefore used with preference are 2,2′-methylenebis(4-methyl-6-tert-butylphenol), 1,6-hexanediol bis(3,5-di-tert-butyl-4-hydroxyphenyl)propionate (Irganox® 259), pentaerythrityl tetrakis[3-(3,5-di-tert-butyl-4-hydroxyphenyl)propionate], and also N,N′-hexamethylenebis-3,5-di-tert-butyl-4-hydroxyhydrocinnamide (Irganox® 1098), and the product Irganox® 245 described above from BASF SE, which has particularly good suitability.

The amount comprised of the antioxidants E), which can be used individually or as a mixture, is from 0.05 up to 3% by weight, preferably from 0.1 to 1.5% by weight, in particular from 0.1 to 1% by weight, based on the total weight of the molding compositions A) to E).

In some instances, sterically hindered phenols having not more than one sterically hindered group in ortho-position with respect to the phenolic hydroxy group have proven particularly advantageous; in particular when assessing colorfastness on storage in diffuse light over prolonged periods.

The molding compositions of the invention can comprise, as component E), from 0.05 to 5% by weight, preferably from 0.1 to 2% by weight, and in particular from 0.25 to 1.5% by weight, of a nigrosine.

Nigrosines are generally a group of black or gray phenazine dyes (azine dyes) related to the indulines and taking various forms (water-soluble, oil-soluble, spirit-soluble), used in wool dyeing and wool printing, in black dyeing of silks, and in the coloring of leather, of shoe creams, of varnishes, of plastics, of stoving lacquers, of inks, and the like, and also as microscopy stains.

Nigrosines are obtained industrially via heating of nitrobenzene, aniline, and aniline hydrochloride with metallic iron and FeCl₃ (the name being derived from the Latin niger=black).

Component E) can be used in the form of free base or else in the form of salt (e.g. hydrochloride).

Further details concerning nigrosines can be found by way of example in the electronic encyclopedia Römpp Online, Version 2.8, Thieme-Verlag Stuttgart, 2006, keyword “Nigrosin” [Nigrosin].

The thermoplastic molding compositions of the invention can comprise, as component E), conventional processing aids, such as stabilizers, oxidation retarders, agents to counteract decomposition by heat and decomposition by ultraviolet light, lubricants and mold-release agents, colorants, such as dyes and pigments, nucleating agents, plasticizers, etc.

Examples of oxidation retarders and heat stabilizers are sterically hindered phenols and/or phosphites and amines (e.g. TAD), hydroquinones, aromatic secondary amines, such as diphenylamines, various substituted members of these groups, and mixtures of these, in concentrations of up to 1% by weight, based on the weight of the thermoplastic molding compositions.

UV stabilizers that may be mentioned, the amounts of which used are generally up to 2% by weight, based on the molding composition, are various substituted resorcinols, salicylates, benzotriazoles, and benzophenones.

Materials that can be added as colorants are inorganic pigments, such as titanium dioxide, ultramarine blue, iron oxide, and carbon black, and also organic pigments, such as phthalocyanines, quinacridones, perylenes, and also dyes, such as anthraquinones.

Materials that can be used as nucleating agents are sodium phenylphosphinate, aluminum oxide, silicon dioxide, and also preferably talc powder.

The thermoplastic molding compositions of the invention can be produced by processes known per se, by mixing the starting components in conventional mixing apparatuses, such as screw-based extruders, Brabender mixers, or Banbury mixers, and then extruding the same. The extrudate can be cooled and pelletized. It is also possible to premix individual components and then to add the remaining starting materials individually and/or likewise in the form of a mixture. The mixing temperatures are generally from 230 to 320° C.

In another preferred mode of operation, components B) and C) and also optionally D) and E) can be mixed with a prepolymer, compounded, and pelletized. The resultant pellets are then solid-phase condensed under an inert gas continuously or batchwise at a temperature below the melting point of component A) until the desired viscosity has been reached.

The thermoplastic molding compositions of the invention feature good flame retardancy and excellent phosphorus stability. These materials are therefore suitable for producing fibers, foils, and moldings of any type. Some examples are now given: plug connectors, plugs, plug parts, cable harness components, circuit mounts, circuit-mount components, three-dimensionally injection-molded circuit mounts, electrical connection elements, and mechatronic components.

The moldings or semifinished products to be produced in the invention from the thermoplastic molding compositions can be used by way of example in the motor vehicle industry, electrical industry, electronics industry, telecommunication industry, information technology industry, entertainment industry, or computer industry, or in vehicles and other conveyances, in ships, in spacecraft, in households, in office equipment, in sports, in medicine, and also generally in articles and in parts of buildings, where these require increased fire protection.

Possible uses of improved-flow polyamides in the kitchen and household sector are for producing components for kitchen devices, e.g. fryers, smoothing irons, and knobs, and also applications in the garden and leisure sector.

### EXAMPLES

The following components were used:

### Component A:

Nylon-6,6 with an intrinsic viscosity IV of 150 ml/g, measured on a 0.5% by weight solution in 96% by weight sulfuric acid at 25° C. to ISO 307. (Ultramid® A27 from BASF SE was used.)

### Component B:

50% concentrate of red phosphorus of average particle size (d₅₀) from 10 to 30 μm in an olefin polymer of: 59.8% by weight of ethylene, 35% by weight of n-butyl acrylate, 4.5% by weight of acrylic acid, and 0.7% by weight of maleic anhydride (component E11) with a melt index MFI (190/2.16) of 10 g/10 min. The copolymer was produced via copolymerization of the monomers at elevated temperature and elevated pressure.

### Component C:

LCP Polyester made from 73 mol % of hydroxybenzoic acid+27 mol % of hydroxynaphthalenecarboxylic acid (Vectra® A950 from Ticona). The production process is described inter alia in EP0125079, ex. 4.

### Component D:

Standard chopped glass fiber for polyamides, length=4.5 mm, diameter=10 μm.

### Component E/2:

N,N′-Hexamethylenebis-3,5-di-tert-butyl-4-hydroxyhydrocinnamide (Irganox® 1098)

### Component E/3:

Ca stearate

### Component E/4:

Zinc oxide

In order to demonstrate the phosphorus-stability improvements described in the invention, appropriate plastics molding compositions were prepared via compounding. To this end, the individual components were mixed in a ZSK 26 (Berstorff) twin-screw extruder with a flat temperature profile at about 270° C. with throughput 20 kg/h, and discharged in the form of a strand, cooled until pelletizable, and pelletized.

The test specimens for the tests listed in table 1 were injection-molded in an Arburg 420C injection-molding machine at a melt temperature of about 270° C. and a mold temperature of about 80° C.

### Phosphorus Exudation Test on Plastics Parts:

A plastics specimen (125×12.5×1.6 mm) was halved and each half was placed in a 10 ml glass beaker. A contact material (10×50×0.125 mm) composed of silver was placed in a short test tube. The three specimens were then placed in a 100 ml screw-top bottle, 5 ml of water were added, and the closed system was placed in a drying oven at 70° C. After 28 days, the test tube was removed, the maximum possible amount of water was added, and the entire contents were placed in a glass beaker. 5 ml of conc. hydrochloric acid were added, and the contents were evaporated almost to dryness. The metal specimen was then removed and rinsed with water, and 1 ml of sulfuric acid was then admixed with the residue, and the contents were again evaporated almost to dryness. 20 ml of water were then added for dilution, 4 ml of 5% potassium peroxodisulfate solution were added, and the mixture was heated for 30 minutes. Phosphorus was then determined photometrically by the molybdenum blue method in μg of phosphorus/plastics specimen.

### Phosphorus Exudation in Water:

About 80 g of standard small specimens (50×6×4 mm, ˜50 pieces) were covered by 150 ml of distilled water in a 250 ml glass beaker, and the total weight of the glass vessel was recorded. The water here must cover the plastics specimens. The water level was marked on the beaker, and the beaker was covered with a watch glass and stored in an oven heated to 60° C. Once every week, water was added to replace the amount lost by evaporation. To measure phosphorus content in the solution, after 14, 30, 50, and 100 days the beaker was cooled, and distilled water was used to make up the volume to precisely 150 ml, and 10 ml solution was taken for analysis after brief swirling. Water was again added to replace the amount taken, and the glass beaker was stored for an appropriate further period until 100 days had expired. Phosphorus content in the aqueous solution was determined by atomic emission spectroscopy (AES), and comprises all of the phosphorus compounds present in the water. Phosphorus stability was documented in ppm (mg/l) of phosphorus as a function of time.

Saturation water absorption value was determined by a method based on ISO 62 at 23° C.

The constitutions of the molding compositions and the results of the tests can be found in the table.

TABLE

| | Comparative | Inventive |
|---|---|---|
| Components [% by wt.] | example | example |
| A | 61.6 | 56.6 |
| B + E/1 | 12 | 12 |
| C | 0 | 5 |
| D | 25 | 25 |
| E/2 + E/3 + E/4 | 0.35 + | 0.35 + |
| | 0.35 + 0.7 | 0.35 + 0.7 |
| Saturation water absorption at | 5.5 | 4.6 |
| 23° C. (% of water) | | |
| Phosphorus exudation in water after | 21/24/28/43 | 9/16/19/35 |
| 14/30/50/100 days at 60° C. | | |
| (ppm of phosphorus) | | |
| Phosphorus exudation by way of gas | 150 μg | 40 μg |
| phase after 28 days at 70° C. | | |
| (μg of phosphorus/specimen) | | |

1-9. (canceled)

10. A thermoplastic molding composition comprising
A) from 10 to 99.6% by weight of a thermoplastic polyamide,
B) from 0.1 to 60% by weight of red phosphorus,
C) from 0.5 to 30% by weight of a liquid-crystalline polyester (LCP),
D) from 0 to 55% by weight of a fibrous or particulate filler or a mixture of these,
E) from 0 to 40% by weight of further additives,
where the sum of the percentages by weight of A) to E) does not exceed 100%.

11. The thermoplastic molding composition according to claim 10 comprising
A) from 20 to 94% by weight
B) from 0.5 to 40% by weight
C) from 0.5 to 15% by weight
D) from 5 to 50% by weight
E) from 0 to 40% by weight.

12. The thermoplastic molding composition according to claim 10 in which component E) is composed of an ethylene copolymer which comprises from 0.1 to 20% by weight of functional monomers.

13. The thermoplastic molding composition according to claim 10 comprising, as component C), a polyester C) composed of:
C₁) from 70 to 100 mol % of units which derive from bisphenol A, from aromatic carboxylic acids, from 4,4′-dihydroxybiphenyl, or from a mixture of these, and
C₂) from 0 to 30 mol % of alkanediols having from 2 to 4 carbon atoms.

14. The thermoplastic molding composition according to claim 10 in which the aromatic carboxylic acids in C1) are composed of isophthalic acid, terephthalic acid, 1,5- or 2,6-hydroxynaphthalenecarboxylic acid, hydroxybenzoic acid, or a mixture of these.

15. The thermoplastic molding composition according to claim 10 in which component C2) is composed of ethylene glycol.

16. The thermoplastic molding composition according to claim 10 in which the copolyester C) is composed of
C₁₁) from 50 to 90 mol % of 4-hydroxybenzoic acid
C₁₂) from 10 to 30 mol % of terephthalic acid or
1,5- or 2,6-hydroxynaphthalenecarboxylic acid or 4,4′-dihydroxybiphenyl, or a mixture of these, and
C₂) from 0 to 20 mol % of ethylene glycol.

17. A process for producing fibers, foils, and moldings which comprises utilizing the thermoplastic molding composition according to claim 10.

18. A fiber, foil, or molding obtainable from the thermoplastic molding composition according to claim 10.
